(19) United States
(12) Patent Application Publication
(10) Pub. No.: US 2006/0042900 A1
(43) Pub. Date: Mar. 2, 2006

(54) Clutch/brake apparatus

(76) Inventors: Yasuhiro Araki, Kanazawa-shi (JP); Kiyokazu Baba, Komatsu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/206,792

(22) Filed: Aug. 19, 2005

(30) Foreign Application Priority Data
Aug. 24, 2004 (JP) 2004-243947

(51) Int. Cl. F16D 67/02

(52) U.S. Cl. 192/18 R

(57) ABSTRACT

A clutch/brake apparatus which enables a driving shaft to be driven by a main driving source and by a sub-driving source without causing any increase in the external size of the apparatus along the longitudinal direction of the driving shaft. In a brake housing of a combination clutch/brake unit provided on one end of the driving shaft, a power transmitting member extending towards the other end of the driving shaft is provided and the sub-driving source is connected to the power transmitting member through a power transmitting mechanism.

### BACKGROUND OF THE INVENTION

1. Field of the Invention

The present invention relates to a clutch/brake apparatus provided with a combination clutch/brake unit for connecting/disconnecting a power from a main driving source to one end of a driving shaft for transmitting the power to a main body of a machine tool.

2. Detailed Description of the Related Art

In a press machine, which is one form of machine tools, for example, it has become common to mount a clutch/brake apparatus so as to be able to easily stop and restart pressing by utilizing rotational energy accumulated in a flywheel. In particular, those with a clutch apparatus and a braking apparatus combined in a single unit is referred to as a combination clutch/brake unit (for example, see Japanese Patent Application Laid-Open No: 7-51898).

Currently in press machines, a so-called inching function is required, which slightly moves a slide when making adjustments or for maintenance and also for inversely rotating the slide driving mechanism.

FIG. 7 shows a conventional clutch/brake apparatus with an inching function. In a clutch/brake apparatus J, a clutch unit L is provided at one end of a driving shaft K while a braking unit M is provided at the other end of the driving shaft K. A flywheel N, which can be rotationally driven by a drive motor (not shown), is attached to a drive-side member of the above-described clutch unit L and a driven-side member being fixed to the driving shaft K. A facing (not shown) is interposed between the drive-side member and the driven-side member so that the rotational power can be connected/disconnected at will.

In the meantime, the drive-side member of the above-described brake unit M is fixed to the driving shaft K and a spur gear O is attached to the driven-side member. A pinion S connects to an inching motor P through a drum brake Q and a reduction gear R, is engaged with the spur gear O. A facing (not shown) is interposed between the drive-side member and the driven-side member so that the rotational power can be connected/disconnected at will.

In the clutch/brake apparatus J with the above-described configuration, the driving force of the drive motor (not shown) is transmitted to the driving shaft K from the flywheel N through the clutch unit L by connecting the clutch unit L and disconnecting the brake unit M.

Meanwhile, by disconnecting the clutch unit L and connecting the brake unit M, the driving force of the drive motor (not shown) is not transmitted to the driving shaft K, with driving shaft K being locked by the brake unit M.

At this time, even if any force for use in rotating the driving shaft K is applied from the slide side of the press machine, the above-described driving shaft K is immovably locked by the actions of the reduction gear R and the drum brake Q, which are connected to the brake unit M.

Furthermore, in the situation where the clutch unit L is disconnected and the brake unit M is connected, the driving force of the inching motor P is transmitted to the driving shaft K through the brake unit M. Therefore, based on the action of the inching motor P, the slide (not shown) of the press machine can be arbitrarily moved through the driving shaft K.

In general, the clutch/brake apparatus in a press machine is positioned on the upper area of the press machine main body. However in the clutch/brake apparatus J shown in FIG. 7, the clutch unit L and the brake unit M are provided at one end and the other end of the driving shaft K, respectively Thus the driving shaft K becomes quite lengthy with driving gear G being interposed in the center so that the entire external appearance including the clutch unit L and the brake unit M becomes extremely large-scale.

Furthermore, when a tandem press line is built with a press machine which includes the clutch/brake apparatus J, a wide space is necessary for maintenance work or assembly between adjacent press machines. Also, the driving shaft has to be removed for maintenance. Therefore, the distance between press machines cannot be shortened thereby causing the inconvenience that the press line must be wastefully lengthened.

In order to overcome the foregoing drawbacks, an objective of the present invention is to provide a clutch/brake apparatus which enables the driving shaft to be driven by a main driving source and by a sub-driving source without causing any increase in the external size of the apparatus along the longitudinal direction of the driving shaft.

### SUMMARY OF THE INVENTION

A first aspect of the present invention provides a clutch/brake apparatus including a combination clutch/brake unit, which is provided on one end portion of a driving shaft, for connecting/disconnecting a power transmitted from a main driving source to the driving shaft that transmits the power to a main body of a machine tool, in which a power transmitting member extending towards the other end of the driving shaft is provided in a brake housing of the combination clutch/brake unit and a sub-driving source is connected to the power transmitting member through a power transmitting mechanism.

A second aspect of the present invention provides the clutch/brake apparatus according to the first aspect of the invention, in which the power transmitting mechanism includes a worm driven by the sub-driving source and a worm wheel which is provided on the power transmitting member and engaged with the worm.

A third aspect of the present invention provides the clutch/brake apparatus according to the first or second aspect of the invention, in which the driving shaft, the combination clutch/brake unit, the power transmitting member, the power transmitting mechanism, the main driving source and the sub-driving source are disposed in a drive housing, which is attached to the main body of the machine tool, to configure an assembly.

A fourth aspect of the present invention provides the clutch/brake apparatus according to any one of the first to third aspects of the invention, in which the machine tool is a press machine.

In the clutch/brake apparatus according to the first aspect of the present invention, a combination clutch/brake unit is provided on one end of a driving shaft and a power transmitting member extending towards the other end of the driving shaft is provided in the brake housing of the unit, while connecting a sub-driving source to the power transmitting member through a power transmitting means. Therefore, compared to the conventional clutch/brake apparatus in which the driving shaft by the sub-driving source can be driven by providing the clutch unit and the brake unit on both ends of the driving shaft, the entire length of the driving shaft can be shortened as short as possible and also the size of the external appearance of the clutch/brake apparatus including the sub-driving source can be reduced.

In the clutch/brake apparatus according to the second aspect of the present invention, the power transmitting mechanism for connecting the sub-driving source with the power transmitting member comprises a worm which is driven by the sub-driving source and a worm wheel which is provided on the power transmitting member. Therefore, by utilizing a self-lock function of a worm gear constituted by the worm and the worm wheel, it becomes possible to lock the rotation of the driving shaft by a simple configuration.

In the clutch/brake apparatus according to the third aspect of the present invention, structural elements are arranged in a drive housing as an assembly. Therefore, it is possible to easily build a machine tool which can be operated by the main driving source and the sub-driving source by attaching the assembly to the main body of an existing machine tool.

In the clutch/brake apparatus according to the fourth aspect of the present invention, the clutch/brake apparatus is mounted to a press machine main body Therefore, it enables to reduce the size of an external appearance of the clutch/brake apparatus of the press machine which comprises an inching function.

### BRIEF DESCRIPTION OF THE DRAWINGS

FIG. 1 is a front sectional view showing a driving assembly which has a clutch/brake apparatus according to the present invention;

FIG. 2 is a front sectional view showing an enlarged view of the main part of the driving assembly shown in FIG. 1;

FIG. 3 is a cross section taken along the line III-III of FIG. 1;

FIG. 4 is an overall plan view showing the external appearance of the driving assembly shown in FIG. 1;

FIG. 5 is an overall front view showing the external appearance of the driving assembly shown in FIG. 1;

FIG. 6 is an overall side view showing the external appearance of the driving assembly shown in FIG. 1; and

FIG. 7 is a front sectional view showing a conventional clutch/brake apparatus.

### DETAILED DESCRIPTION OF THE INVENTION

Embodiments of the present invention will be described in detail hereinafter by referring to the accompanying drawings.

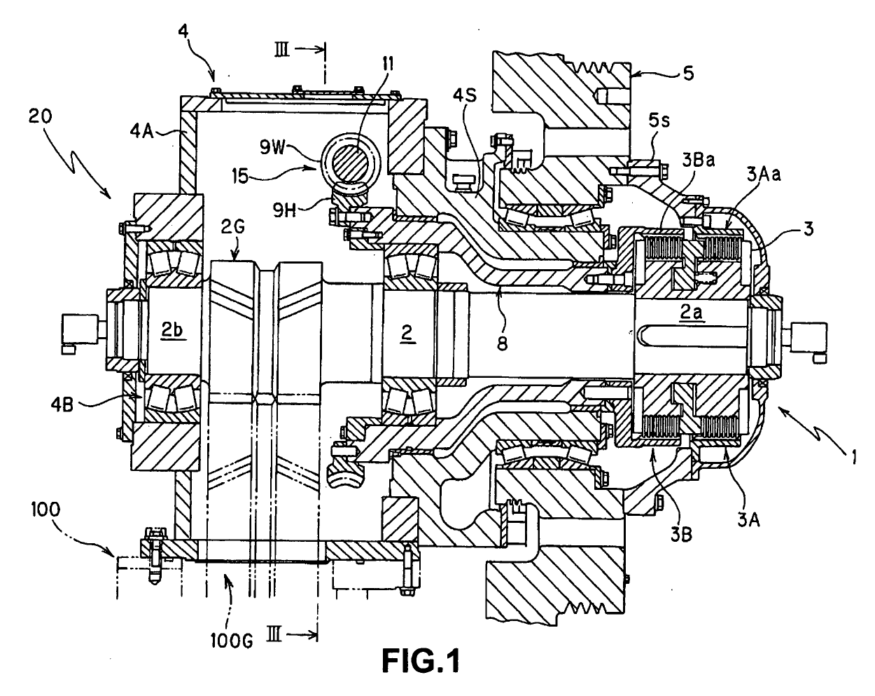

FIG. 1-FIG. 4 illustrate an embodiment in which the clutch/brake apparatus according to the present invention is applied to a press machine with an inching function as one form of machine tools. A clutch/brake apparatus 1 of this embodiment comprises a driving shaft 2, and a wet-type combination clutch/brake unit 3 provided on one end portion 2a of the driving shaft 2.

In the driving shaft 2, the other end portion 2b is supported through a bearing 4B to a drive housing 4 mounted on the upper portion of a main body 100 of a press machine (machine tool) and, more specifically, to a gear box 4A formed in the center of the drive housing 4. A driving gear 2G of the driving shaft 2, which is disposed in a manner extending in the horizontal direction, is disposed within the gear box 4A and also is engaged with a driven gear 100G provided on the main body 100 side. Although the driving gear 2G and the driven gear 100G are illustrated as double helical gears in FIGS. 1 to 4, they may be spur gears or two pairs of helical gears and may be appropriately selected at the time of designing a slide driving mechanism.

In the meantime, the combination clutch/brake unit 3 provided to the driving shaft 2 is a combination of two multiple-disk clutches, one of which is provided on a clutch mechanism section 3A and the other of which is provided on a brake mechanism section 3B. Each of the multi-disk clutches of the clutch mechanism section 3A and the brake mechanism section 3B is the so-called multiple wet clutch which connects/disconnects the rotational power while being immersed in a coolant oil.

In the multiple-disk clutch of the clutch mechanism section 3A, disks 3Ad and plates 3Ap are alternately disposed. The plates 3Ap (or the disks 3Ad) are engaged with the inner peripheral surface of a clutch housing 3Aa to be movable in the axial direction of the driving shaft 2. Further, the disks 3Ad (or the plates 3Ap) are engaged with the outer peripheral surface of a center 3c to be movable in the axial direction of the driving shaft 2.

A pusher 3p is provided between the respective multiple-disk clutches of the clutch mechanism section 3A and the brake mechanism section 3B to be movable in the axial direction of the driving shaft 2. A retaining plate 3Ac is provided on an end portion in the center 3c in the opposite direction of the brake mechanism section 3B. When the multiple-disk clutch of the clutch mechanism 3A is pushed by the pusher 3p, the rotational power is transmitted between the clutch housing 3Aa and the center 3c. When there is no push-force by the pusher 3p, the transmission of the rotational power between the clutch housing 3Aa and the center 3c is disconnected. The above-described center 3c is fixed to the driving shaft 2.

In the multiple-disk clutch of the brake mechanism 3B, disks 3Bd and plates 3Bp are alternately disposed. The plates 3Bp (or the disks 3Bd) are engaged with the inner peripheral surface of a brake housing 3Ba to be movable in the axial direction of the driving shaft 2. Further, the disks 3Bd (or the plates 3Bp) are engaged with the outer peripheral surface of the above-described center 3c which is common to that of the clutch mechanism to be movable in the axial direction of the driving shaft 2.

A retaining plate 3Bc is provided on an end portion in the center 3c in the opposite direction of the clutch mechanism section 3A. When the multiple-disk clutch of the brake mechanism 3B is pressed by the pusher 3p, the rotational power is transmitted between the brake housing 3Ba and the center 3c. When there is no pressure by the pusher 3p, the transmission of the rotational power between the brake housing 3Ba and the center 3c is disconnected.

The pusher 3p is normally pressed in the direction of the brake mechanism by a biasing force of a spring 3s. In the meantime, it is so constituted that the pusher 3p is pressed in the direction of the clutch mechanism against the biasing force by a fluid pressure applied to the pusher 3p.

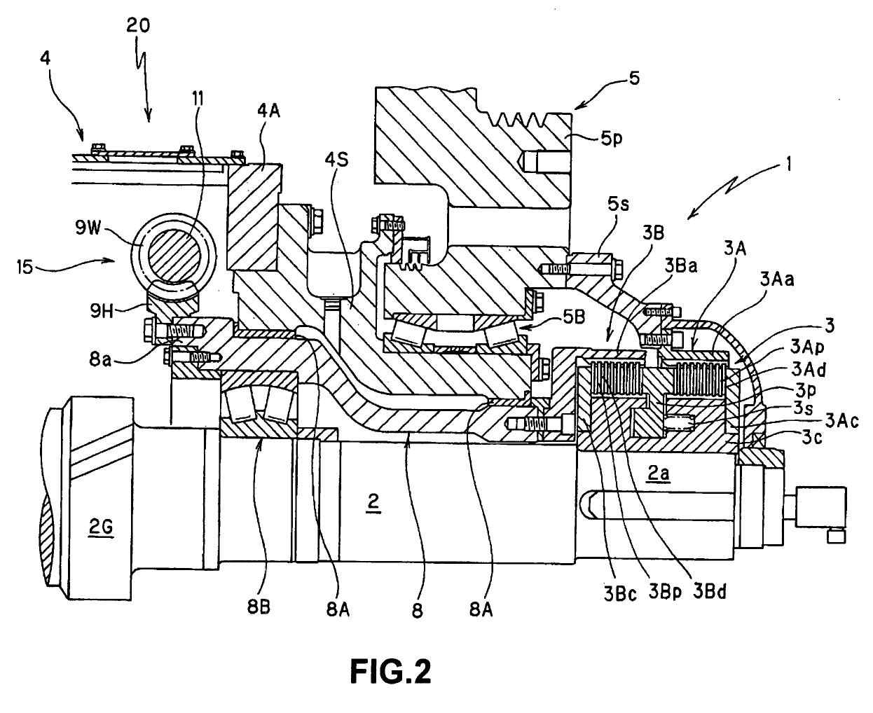

In the above-described combination clutch/brake unit 3, the clutch mechanism section 3A is disposed on the end portion side (on the right side of FIG. 1 and FIG. 2) of the driving shaft 2 and the brake mechanism section 3B is disposed on the center side (on the left side of FIG. 1 and FIG. 2) of the driving shaft 2. A flywheel 5 is integrally mounted to the clutch housing 3Aa of the clutch mechanism section 3A through a support ring 5s.

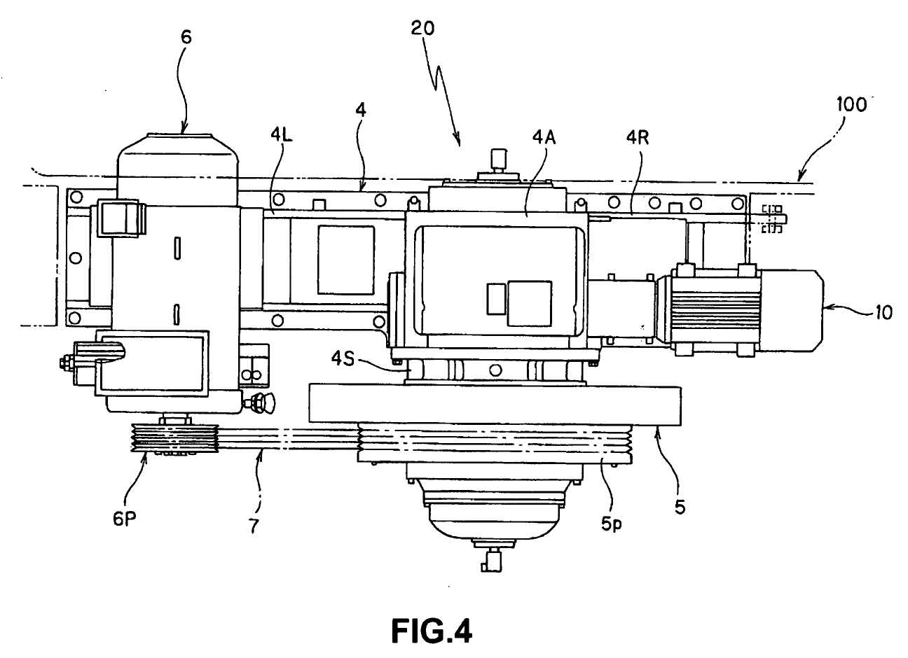

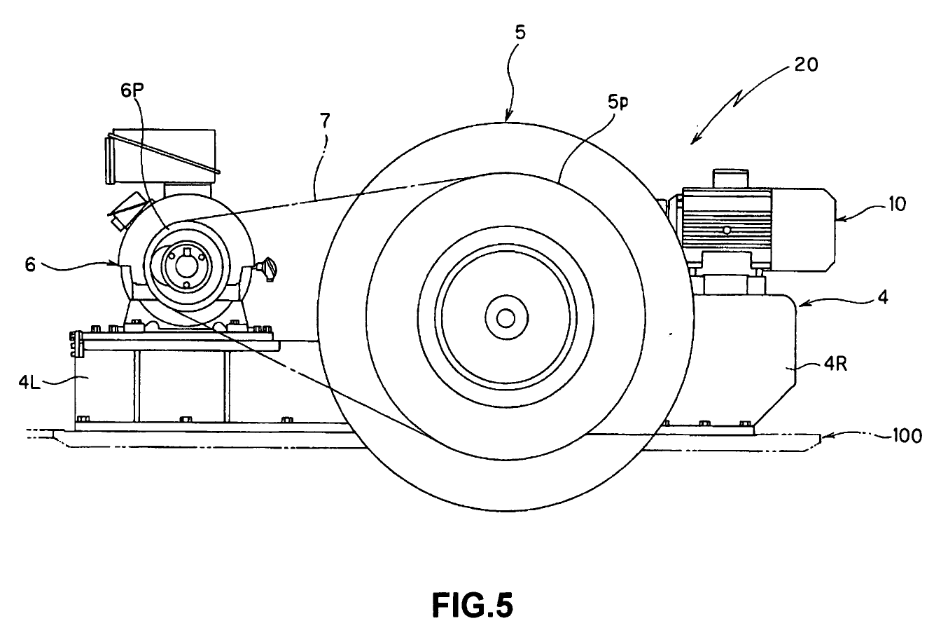

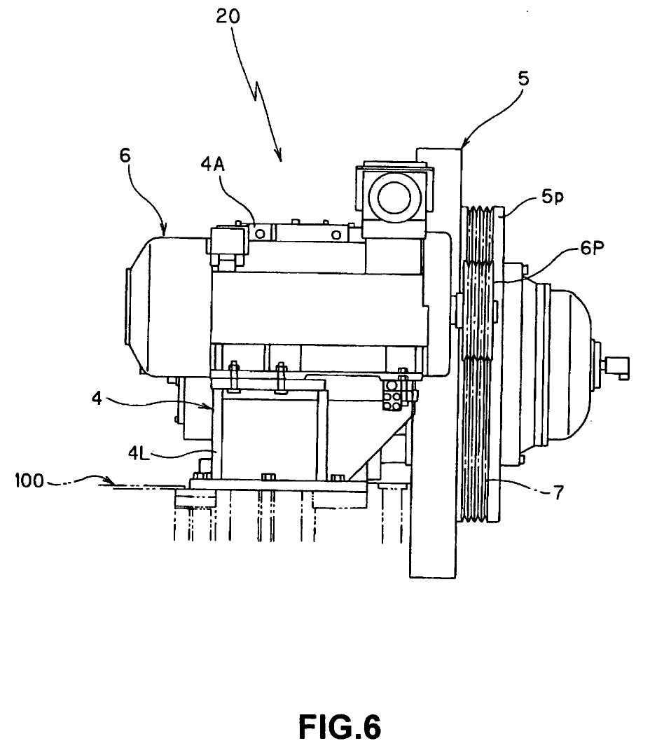

The above-described flywheel 5 is rotatably supported through a bearing 5B to a flywheel supporter 4S which is fixed to the gear box 4A of the drive housing 4. As shown in FIG. 4-FIG. 6, a driving pulley 6P is attached to a main shaft 6a of a main motor 6 (main driving source) which is mounted to a frame 4L of the housing 4. In addition, a driven pulley 5p is formed in the above-described flywheel 5 and a transmission belt 7 is wound between the above-described driving pulley 6P and the driven pulley 5p of the flywheel 5.

As shown in FIG. 1 and FIG. 2, an inching supporter (a power transmitting member) 8 which extends towards the other end portion 2B of the driving shaft 2 is integrally mounted to the brake housing 3Ba of the brake mechanism section 3B disposed on the center side of the driving shaft 2.

The above-described inching supporter 8 is a member which is substantially cylindrical-shape and surrounds the driving shaft 2. It is rotatably supported by the inner periphery of the above-described flywheel supporter 4S through bushes 8A, 8A and is also rotatably supported to the outer periphery of the driving shaft 2 through a bearing 8B.

Further, in the above-described inching supporter 8, an end portion 8a on the opposite side (on the left side of the drawing) of the side connected to the brake housing 3Ba faces towards the inside of the gear box 4A in the drive housing 4. Also, a worm wheel 9H in a ring shape is attached to the end portion 8a of the above-described inching supporter 8.

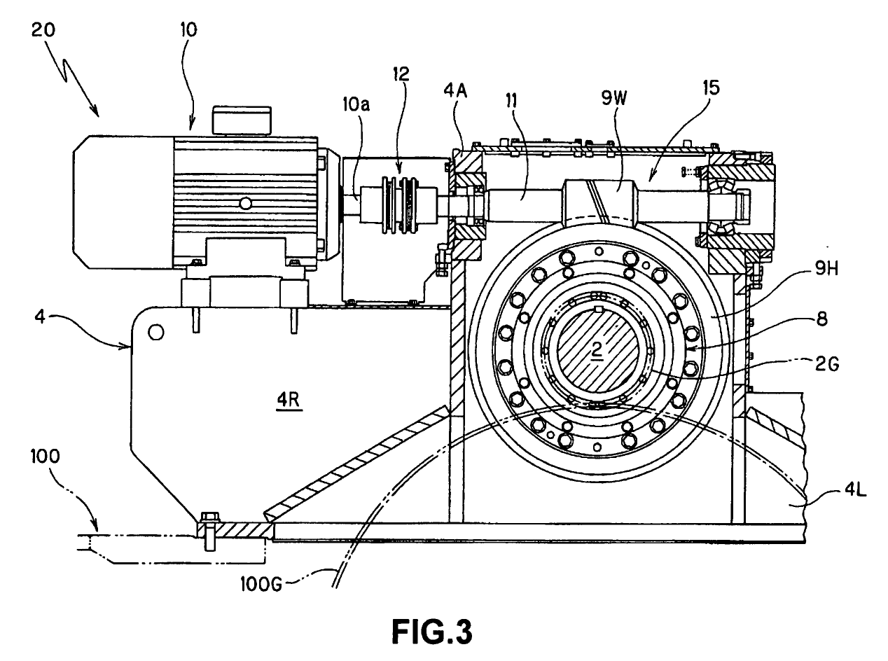

In the meantime, as shown in FIG. 3, in a main shaft 10a of an inching motor (sub-driving source) 10 mounted on a frame 4R of the drive housing 4, a driving shaft 11 which is rotatably supported by the gear box 4A of the drive housing 4 is connected through a coupling 12. A worm 9W is fixed to the above-described driving shaft 1.

Further, the above-described worm 9W is engaged with the worm wheel 9H attached to the inching supporter 8. A power transmitting mechanism 15 for connecting the inching motor 10 (sub-driving source) and the inching supporter 8 (power transmitting member) is constituted of the above-described coupling 12, the driving shaft 11, the worm 9W, and the worm wheel 9H.

The above-described worm 9W and the above-described worm wheel 9H are disposed inside the gear box 4A in which the above-described gear 2G is built-in, and engage with each other. Thus, the lubricating oil supplied to the engaged portions is collected together with the lubricating oil supplied to the above-described driving gear 2G so that the lubricating oil can be easily managed.

The above-described driving shaft 2, the combination clutch/brake unit 3, the flywheel 5, the main motor 6, the inching supporter 8, the inching motor 10, the power transmitting mechanism 15 and the like are integrally mounted to each other through the drive housing 4, thereby constituting a single driving assembly 20 (assembly). The press machine is formed by mounting the above-described driving assembly 20 on the upper portion of the main body 100.

With the clutch/brake apparatus 1 having the configuration as described above, compared to the conventional clutch/brake apparatus comprising the inching function (that is, the clutch/brake apparatus which enables the clutch/brake shaft to be driven by the inching motor by providing the drive-side clutch unit and the brake-side clutch unit on both ends of the driving shaft), it is possible to shorten the entire length of the driving shaft 2 as short as possible. Also, since the combination clutch/brake unit 3 is provided only on one end of the driving shaft 2, it becomes possible to reduce the size of the external appearance of the above-described driving shaft 2 along the longitudinal direction.

Therefore, when building a tandem press line by the press machine which comprises the above-described clutch/brake apparatus 1, a wide space is not required for the maintenance work or assembling work of the above-described clutch/brake apparatus 1. Thus, the pitch between the adjacent press machines can be formed as short as possible so that the entire length of the press line can be shortened. Accordingly, it allows to save the space for building the above-described press line. Further, since the distance in between the press machines can be shortened, it becomes easier for a work conveying device to follow the operating speed of the press machine. Therefore, it is possible to increase the manufacturing speed in the press line.

In the clutch/brake apparatus 1 having the above-described configuration, when a fluid pressure is applied to the pusher 3p by operating the combination clutch/brake unit 3, the pusher 3p is pressed in the direction of the clutch mechanism section 3A against the biasing force of the spring 3s. Thereby, it is realized under the condition that the clutch mechanism section 3A is connected and the brake mechanism section 3B is disconnect, and the rotational power of the flywheel 5 which is rotationally driven by the main motor 6 is transmitted to the driving shaft 2 through the above-described clutch mechanism section 3A. The rotation of the driving shaft 2 is then transmitted from the driving gear 2G to the driven gear 100G, thereby driving the slide (not shown) in the press machine.

In the meantime, when the fluid pressure applied to the pusher 3p is released by operating the combination clutch/brake unit 3, the pusher 3p is pressed in the direction of the brake mechanism section 3B by the above-described biasing force. Thereby, it is realized under the condition that the clutch mechanism section 3A is disconnected and the brake mechanism section 3B is connected. Since the above-described clutch mechanism section 3A is disconnected, the rotational power of the flywheel 5 which is rotationally driven by the main motor 6 is not transmitted to the driving shaft 2 so that the action of the slide (not shown) in the press machine is to be stopped. Further, by the connection of the brake mechanism section 3B, the above-described driving shaft 2 is immovably locked.

That is, even if a force for rotating the driving shaft 2 is applied thereto from the slide side in the press machine, the above-described driving shaft 2 is immovably locked by a self-lock function of the worm gear composed of the above-described worm 9W and the worm wheel 9H since the above-described driving shaft 2 is connected to the inching motor 10 through the brake mechanism section 3B, the inching supporter 8, and the power transmitting mechanism 15 and the worm 9W connected to the inching motor 10 is engaged with the worm wheel 9H which is fixed to the inching supporter 8.

Meanwhile, by driving the inching motor 10 in the state where the above-described clutch mechanism section 3A is disconnected and the brake mechanism section 3B is connected, the driving force of the inching motor 10 is transmitted to the driving shaft 2 through the driving shaft 11, the worm 9W, the worm wheel 9H, the inching supporter 8, and the brake mechanism section 3B. Further, the rotation of the driving shaft 2 is transmitted to the driven gear 100G from the driving gear 2G so that the slide (not shown) in the press machine is arbitrarily moved according to the action of the inching motor 10.

After completing the inching operation of the slide by the above-described inching motor 10, the combination clutch/brake unit 3 is operated to connect the clutch mechanism section 3A and to disconnect the brake mechanism section 3B. Thereby, the slide in the press machine is to be moved again by the rotational driving power of the main motor 6.

Even in the state where the clutch mechanism section 3A is disconnected, the flywheel 5 continues to rotate by the drive of the main motor 6. Thus, it is needless to say that the press machine can immediately return to the regular operation state by connecting the clutch mechanism section 3A after completing the inching operation of the slide by the inching motor 10.

In the clutch/brake apparatus 1 of the above-described embodiment, the inching motor 10 (sub-driving source) and the inching supporter 8 (power transmitting member) are connected by the power transmitting mechanism 15 which includes the worm 9W fixed to the driving shaft 11 and the worm wheel 9H fixed to the inching supporter 8. However, it is possible to use a combination of spur gears (may be straight gear, helical gear, or double helical gear) which engage with each other instead of using the combination of the worm and the worm wheel as described above.

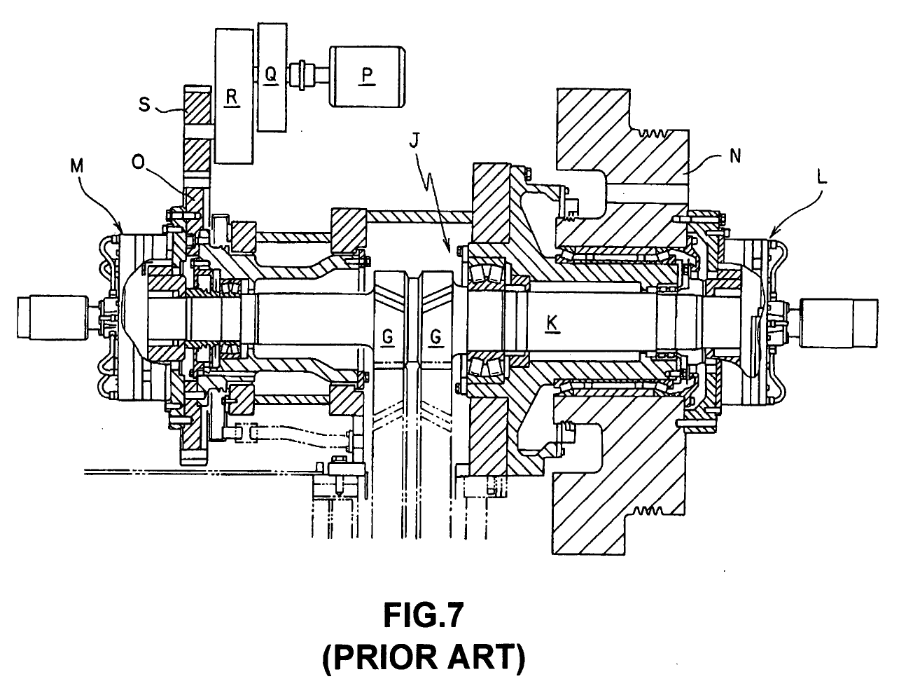

However, in a gear sequence in which the spur gears are engaged with each other, the self-lock function as in the case of the worm gear in which the worm and the worm wheel are engaged with each other does not work. Thus, as in the case of the brake unit M in the conventional clutch/brake J shown in FIG. 7, it is necessary to configure such that a reduction gear, a drum brake and the like are interposed between the gear sequence and the inching motor for locking the driving shaft by the actions of the above-described reduction gear and the drum brake when a force is applied to rotate the clutch/brake shaft from the slide side of the press machine.

Further, although a combination clutch/brake unit using a multiple wet clutch as the base is employed in the above-described embodiment, it is obviously possible to employ a combination clutch/brake unit using an air-cooled dry clutch as the base, whose basic configuration is almost the same as that of the multiple wet clutch. Needless to say, there is no difference in the operation styles and the working effects in any of the clutch/brake apparatuses employing the wet type or dry type.

Further, the above-described embodiment has been described by referring to the case where the clutch/brake apparatus according to the present invention is applied to the press machine with the inching function as one form of machine tools. However, it is needless to say that the present invention is not limited to be applied to the press machine of the embodiment but can be very effectively applied to various machine tools which require driving operations by a main driving source and driving operations by a sub-driving source.

What is claimed is:

1. A clutch/brake apparatus comprising a combination clutch/brake unit, which is provided on one end portion of a driving shaft, for connecting/disconnecting a power transmitted from a main driving source to the driving shaft that transmits the power to a main body of a machine tool, wherein
a power transmitting member extending towards the other end of the driving shaft is provided in a brake housing of the combination clutch/brake unit and a sub-driving source is connected to the power transmitting member through a power transmitting mechanism.

2. The clutch/brake apparatus according to claim 1, wherein the power transmitting mechanism comprises a worm driven by the sub-driving source and a worm wheel which is provided on the power transmitting member and engaged with the worm.

3. The clutch/brake apparatus according to claim 1, wherein the driving shaft, the combination clutch/brake unit, the power transmitting member, the power transmitting mechanism, the main driving source and the sub-driving source are disposed in a drive housing, which is attached to the main body of the machine tool, to configure an assembly.

4. The clutch/brake apparatus according to claim 2, wherein the driving shaft, the combination clutch/brake unit, the power transmitting member, the power transmitting mechanism, the main driving source and the sub-driving source are disposed in a drive housing, which is attached to the main body of the machine tool, to configure an assembly.

5. The clutch/brake apparatus according to claim 1, wherein the machine tool is a press machine.

6. The clutch/brake apparatus according to claim 2, wherein the machine tool is a press machine.

7. The clutch/brake apparatus according to claim 3, wherein the machine tool is a press machine.

8. The clutch/brake apparatus according to claim 4, wherein the machine tool is a press machine.
